(19) United States
(12) Patent Application Publication
(10) Pub. No.: US 2015/0254559 A1
(43) Pub. Date: Sep. 10, 2015

(54) SETTING SUPPORT DEVICE, AND SETTING SUPPORT METHOD

(71) Applicant: FUJITSU LIMITED, Kawasaki-shi (JP)

(72) Inventors: Tetsuya UCHIUMI, Kawasaki (JP); Shinya Kitajima, Inagi (JP); Shinji Kikuchi, Yokohama (JP); YASUHIDE MATSUMOTO, Kawasaki (JP)

(21) Appl. No.: 14/606,531

(22) Filed: Jan. 27, 2015

(30) Foreign Application Priority Data
Mar. 6, 2014 (JP) 2014-044420

(51) Int. Cl. G06N 5/02; G06N 5/04

(52) U.S. Cl. CPC G06N 5/027; G06N 5/046

(57) ABSTRACT

A setting support device generates a setting of parameters common to a plurality of devices and a condition used for the setting as a first rule based on information relating to settings of the parameters performed for the plurality of devices in the past. In addition, the setting support device generates a setting of parameters common to the plurality of devices and a condition used for the setting as a second rule for each generation based on information of each generation that relates to settings of the parameters performed for the plurality of devices in the past. The setting support device compares the first rule and the second rule with each other in relation to the setting of the parameters that is common, specifies a different rule, and calculates an index representing a degree of certainty of the specified different rule.

### CROSS-REFERENCE TO RELATED APPLICATION

This application is based upon and claims the benefit of priority of the prior Japanese Patent Application No. 2014-044420, filed on Mar. 6, 2014, the entire contents of which are incorporated herein by reference.

### FIELD

The embodiment discussed herein is related to a setting support program, a setting support device, and a setting support method.

### BACKGROUND

Recently, cloud systems each being capable of using a plurality of computing resources present on a network as user's computing resources using a technology for virtualizing a server or a network are used. Such cloud systems are increased in scale and are complicated and, for example, parameters relating to additional installation of devices or designs of the systems are added or changed.

A system is designed in accordance with a change in the system. In the design of a system, for example, a designer creates a setting rule for setting parameters relating to the design. The setting rule is created, for example, based on settings of parameters that are performed in a plurality of systems in the past.

In addition, there is a technology for automatically creating a setting rule. According to such a technology, an information processing apparatus receives configuration data relating to a plurality of computers, analyzes the configuration data, and creates a configuration rule based on a result of the analysis. In the configuration rule, a variable parameter setting rule is included (for example, see Japanese Laid-open Patent Publication No. 2009-048611 and Japanese Laid-open Patent Publication No. 10-097413).

However, there is a problem in that it is difficult to acquire the degree of certainty of a setting rule of parameters for a designer. In other words, in a case where there are many errors in the settings of parameters performed in the past, a setting rule that is created based on the settings of parameters performed in the past is not accurate. In a case where an erroneous setting of parameters can be removed when a setting rule is created, an accurate setting rule can be created. However, since there is no information representing whether or not a setting of parameters is erroneous, an erroneous setting of parameters is removed. Thus, it is difficult to acquire whether or not a setting rule of parameters is accurate for the designer.

### SUMMARY

According to an aspect of an embodiment, a non-transitory computer-readable recording medium stores a setting support program. The setting support program causes a computer to execute a process. The process includes generating a setting of parameters common to a plurality of devices and a condition used for the setting as a first rule based on information relating to settings of the parameters performed for the plurality of devices in the past. The process includes generating a setting of parameters common to the plurality of devices and a condition used for the setting as a second rule for each generation based on information of each generation that relates to settings of the parameters performed for the plurality of devices in the past. The process includes comparing the first rule and the second rule with each other in relation to the setting of the parameters that is common, specifying a different rule and calculating an index representing a degree of certainty of the specified different rule.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram that illustrates the configuration of a setting support device according to an embodiment;

FIG. 2 is a diagram that illustrates an example of a parameter setting causing a problem;

FIG. 3A is a diagram (1) that illustrates an example of a parameter setting history;

FIG. 3B is a diagram (2) that illustrates an example of a parameter setting history;

FIG. 4A is a diagram (1) that illustrates an example of a rule extraction process;

FIG. 4B is a diagram (2) that illustrates an example of a rule extraction process;

FIG. 4C is a diagram (3) that illustrates an example of a rule extraction process;

FIG. 5 is a diagram that illustrates an example of specifying different rules;

FIG. 6A is a diagram that illustrates an example of an output of degrees of reliability in a table form;

FIG. 6B is a diagram that illustrates an example of an output of degrees of reliability in a graph form;

FIG. 7 is a diagram that illustrates a flowchart of a setting support process according to an embodiment; and

FIG. 8 is a diagram that illustrates an example of a computer executing a setting support program.

### DESCRIPTION OF EMBODIMENT

Preferred Embodiments of the Present Invention will be explained with reference to accompanying drawings. However, the embodiments are not limited thereto.

### Configuration of Setting Support Device

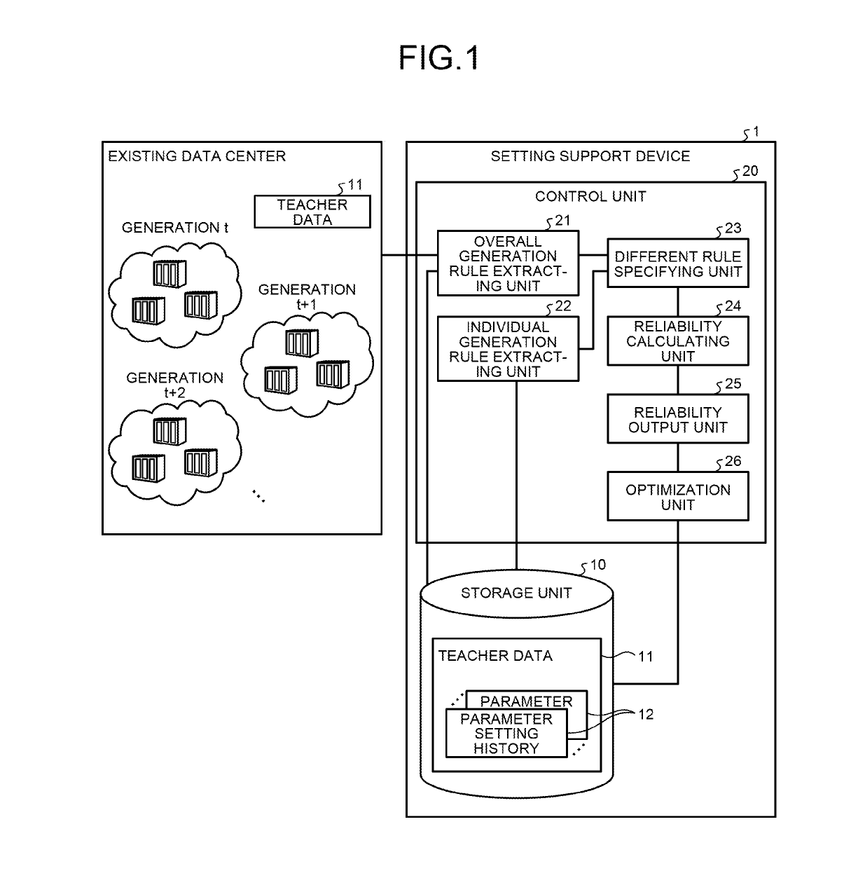

FIG. 1 is a functional block diagram that illustrates the configuration of the setting support device according to an embodiment. A setting support device 1 supports the setting of parameters used for the design of a system installed at a data center. In other words, by creating a setting of parameters as a rule (referred to as a setting rule) based on information of setting of parameters (teacher data 11) performed in a plurality of existing systems, the setting support device 1 performs an appropriate setting when a setting (changing) of parameters, for example, to be performed in accordance with a configuration change or the like is performed. Here, a setting rule is a rule for setting parameters relating to the design and is formed by conditions and values. The setting rule, for example, is a rule for setting values of parameters set in an environment setting file (configuration file). Since the setting support device 1 creates a setting rule based on information of all the settings performed in a plurality of systems in the past, in a case where there are many errors in the settings of parameters, there is a problem in that the created setting rule is not accurate.

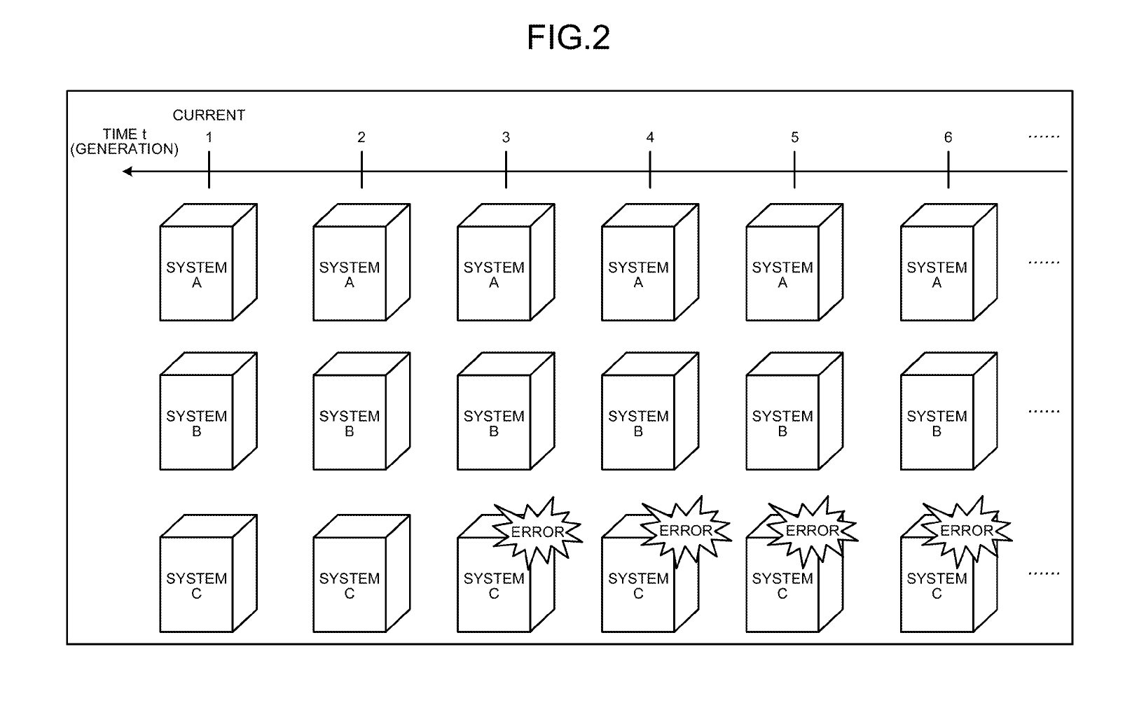

Here, the problem of the setting rule not being accurate in a case where there are many errors in settings of parameters will be described with reference to FIG. 2. FIG. 2 is a diagram that illustrates an example of a parameter setting causing the problem. As illustrated in FIG. 2, for example, a plurality of systems A, B, and C installed to a data center are assumed to be managed for a plurality of generations. Each system managed for a plurality of generations is assumed to have setting information of parameters as teacher data 11. The setting support device 1 generates setting rules of parameters of the plurality of systems A, B, and C installed to the data center, for example, based on setting information (teacher data 11) of the parameters of all the systems managed for a plurality of generations. At this time, for a common parameter, in a case where there are many errors in the setting information of the parameter, the setting support device 1 creates setting information having many errors as setting information of this parameter. In the example illustrated in FIG. 2, for a common parameter of the system C of Generations 3 to 6, it is assumed that there is an error in the setting information of the parameter in Generations 3 to 6, and there is no error in the setting information of the parameter in Generations 1 and 2. The setting support device 1, for this common parameter, creates an erroneous setting rule by using the setting information of the parameter having many errors.

Thus, the setting support device 1 according to the embodiment generates a setting rule used for setting parameters for each generation by using setting information (teacher data 11) of parameters for each generation of an existing data center. Then, the setting support device 1 calculates the degrees of reliability of setting rules for which common parameters are different from each other and supports the generation of an appropriate setting rule.

Here, a generation, for example, represents a time division. In other words, a generation represents a time point determined in advance as a time point when the setting information of parameters of a plurality of systems installed to the data center is acquired. The time division, for example, may be one hour, two hours, or 24 hours. In other words, the time division may be a time point that is determined in advance. In addition, as another example, a generation represents a division according to a change in the configuration of systems and the like inside a data center. In other words, a generation represents a time point when the configuration of systems and the like is changed as a time point when the setting information of parameters of a plurality of systems installed to a data center is acquired. A division according to a configuration change, for example, may be a time point when a system is added or a time point when a parameter is changed. In other words, the division according to a configuration change may be a time point when a certain configuration is changed. As the generation, for example, “1” represents the current time point, and, as the number representing a generation is smaller, the generation is a newer generation. Here, while a generation has been described as a time division or a division according to a configuration change, the generation is not limited thereto, but the generation may be a division combining the time division and the division according to a configuration change.

Hereinafter, description will be presented as a generation being a time division.

Referring back to FIG. 1, the setting support device 1 includes a storage unit 10 and a control unit 20.

The storage unit 10 corresponds to a storage device such as a nonvolatile semiconductor memory element, for example, a flash memory or a ferroelectric random access memory (FRAM) (registered trademark). The storage unit 10 includes a parameter setting history 12 as the teacher data 11. The parameter setting history 12 stores setting information of parameters of a plurality of systems installed to an existing data center. The parameter setting history 12 stores setting information of parameters for each generation.

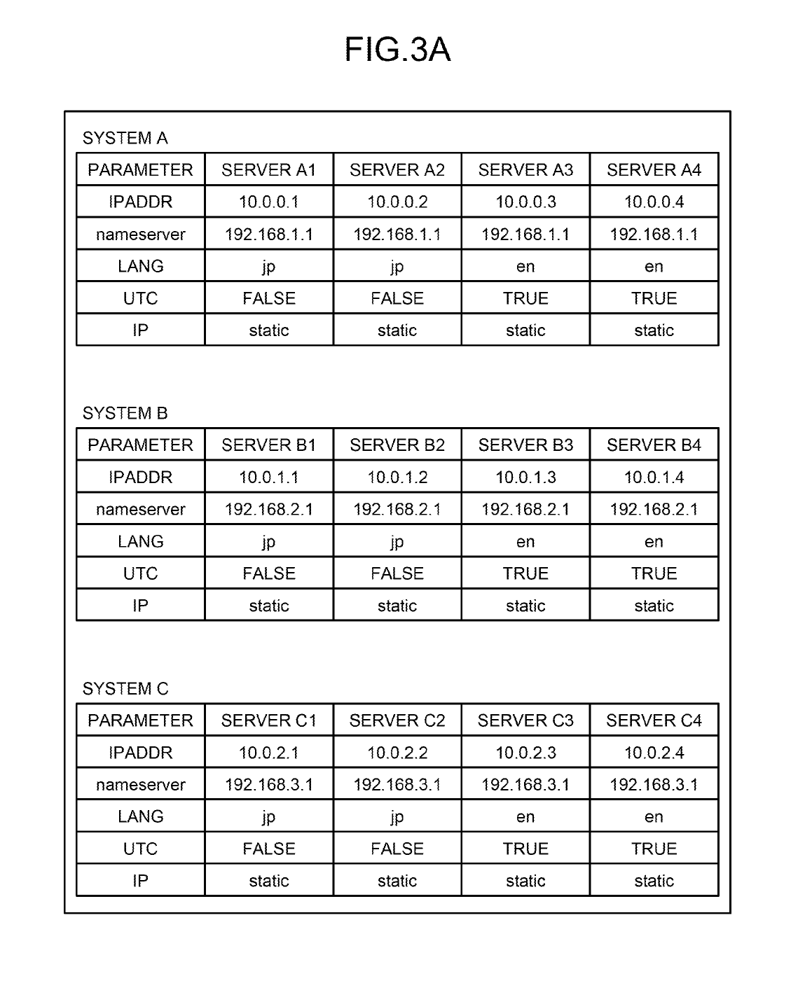

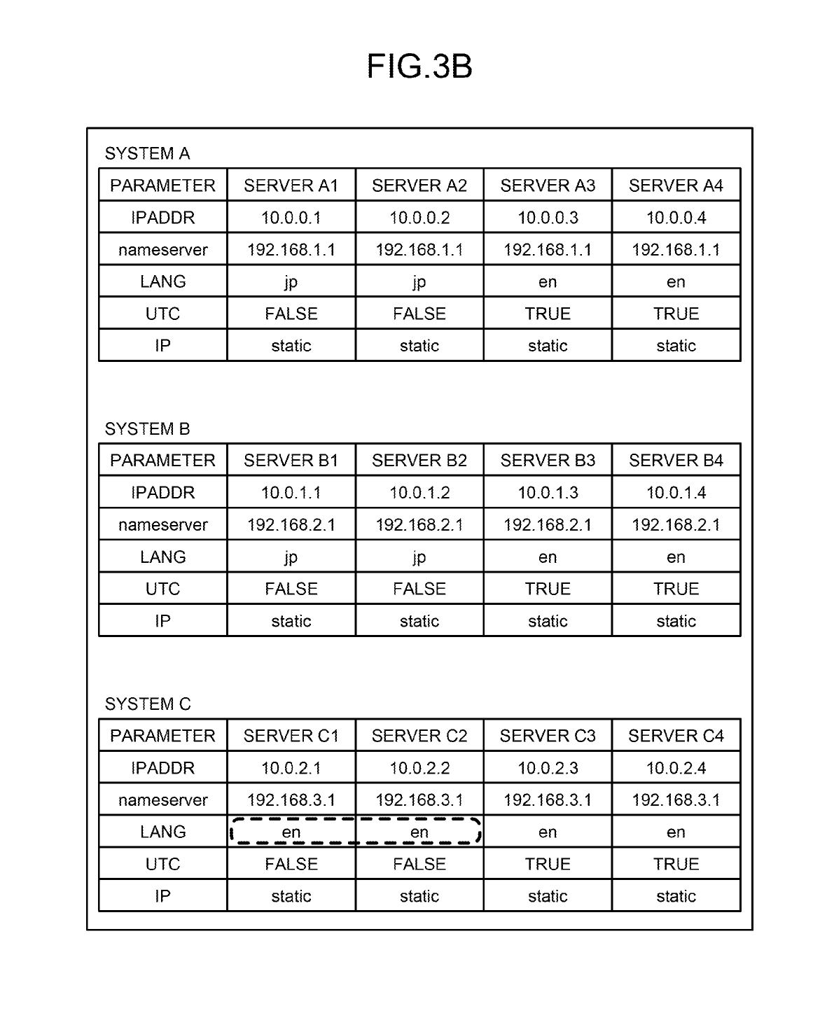

Here, an example of the parameter setting history 12 will be described with reference to FIGS. 3A and 3B. FIGS. 3A and 3B are diagrams that illustrate examples of the parameter setting history.

FIG. 3A is the parameter setting history 12 having no error that is illustrated in FIG. 2 and is a parameter setting history 12 of Generation 1 and Generation 2. As illustrated in FIG. 3A, the parameter setting history 12 of a system A stores a parameter and servers A1, A2, A3, and A4 in association with each other. The servers A1, A2, A3, and A4 are the names of servers that are installed to the existing system A. Here, while four servers are installed, the number of servers may be changed based on the design of the system.

The parameters are parameters used for the design of the system. Here, the parameters include “IPADDR”, “nameserver”, “LANG”, “UTC”, and “IP”. “IPADDR” represents an IP address of a server. In addition, “nameserver” represents an IP address of a domain name service (DNS). “LANG” represents a use language of a server. “UTC” represents whether or not the coordinate universal time is used. For example, in a case where “UTC” is “TRUE”, it represents that the coordinate universal time is used, and, in a case where “UTC” is “FALSE”, it represents that the coordinate universal time is not used. “IP” represents whether the allocation of an IP address is dynamic or static. For example, in a case where “IP” is “dhcp”, it represents dynamic allocation, and, in a case where “IP” is “static”, it represents static allocation.

In each server, values of such parameters are set. As an example, in the case of the server A1, “10.0.0.1” is set to the parameter “IPADDR”, and “192.168.1.1” is set to the parameter “nameserver”. In addition, “jp” is set to the parameter “LANG”, “FALSE” is set to the parameter “UTC”, and “static” is set to the parameter “IP”. Also for the systems B and C illustrated in FIG. 3A, similar to the system A, the parameter setting history 12 is stored in the storage unit 10.

FIG. 3B is a parameter setting history 12 having an error that is illustrated in FIG. 2 and is the parameter setting history 12 of Generations 3 to 6. As illustrated in FIG. 3B, for the systems A to C, similar to the systems A to C illustrated in FIG. 3A, the parameter setting history 12 for each generation is stored in the storage unit 10. As the setting information of parameters having an error, for servers C1 and C2 of a system C, in a case where the value of the parameter “UTC” is “FALSE”, “en” is set to the value of the parameter “LANG”. On the other hand, in the setting information of parameters having no error, as illustrated in FIG. 3A, for the servers C1 and C2 of the system C, in a case where the value of the parameter “UTC” is “FALSE”, “jp” is set to the value of the parameter “LANG”.

Referring back to FIG. 1, the control unit 20 includes an internal memory used for storing programs defining various processing sequences and control data and performs various processes according thereto. Then, the control unit 20, for example, corresponds to an electronic circuit of an integrated circuit such as an application specific integrated circuit (ASIC) or a field programmable gate array (FPGA). Alternatively, the control unit 20 corresponds to an electronic circuit such as a central processing unit (CPU) or a micro processing unit (MPU). In addition, the control unit 20 includes: an overall generation rule extracting unit 21; an individual generation rule extracting unit 22; a different rule specifying unit 23; a reliability calculating unit 24; a reliability output unit 25; and an optimization unit 26. The overall generation rule extracting unit 21 is an example of a first generation unit. In addition, the individual generation rule extracting unit 22 is an example of a second generation unit. The reliability calculating unit 24 is an example of a calculation unit.

The overall generation rule extracting unit 21 extracts a setting rule of parameters common to a plurality of systems by using the parameter setting histories 12 of all the generations. For example, the overall generation rule extracting unit 21 specifies a common portion in units of systems from the parameter setting histories 12 of a plurality of systems belonging to all the generations by using a clustering technique. Then, the overall generation rule extracting unit 21 extracts a setting rule from a result of the clustering. Here, as the clustering technique, any kind of clustering technique may be used.

The individual generation rule extracting unit 22 extracts a setting rule of parameters common to a plurality of systems by using the parameter setting history 12 of each generation for each generation. For example, the individual generation rule extracting unit 22 specifies a common portion in units of systems from the parameter setting histories 12 of the plurality of systems belonging to each generation for each generation by using a clustering technique. Then, the individual generation rule extracting unit 22 extracts a setting rule from a result of the clustering. Here, the clustering technique used by the individual generation rule extracting unit 22 is assumed to be the same as the clustering technique used by the overall generation rule extracting unit 21.

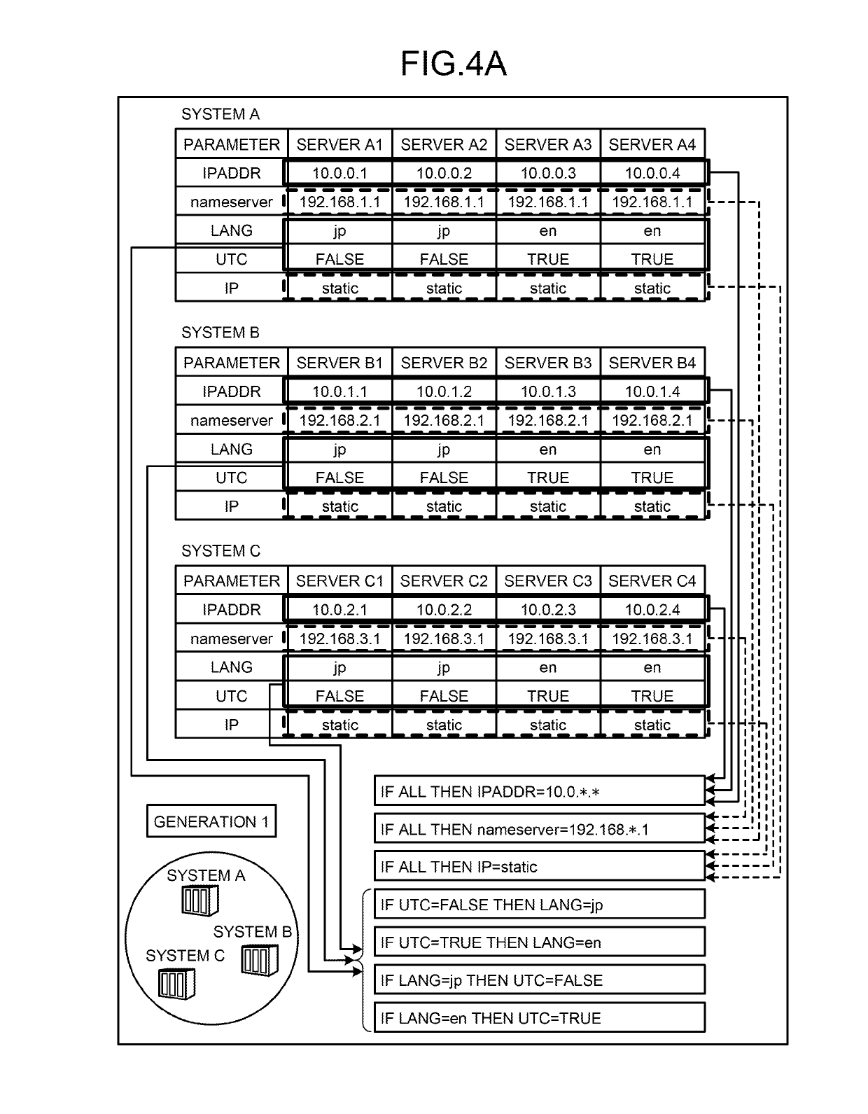

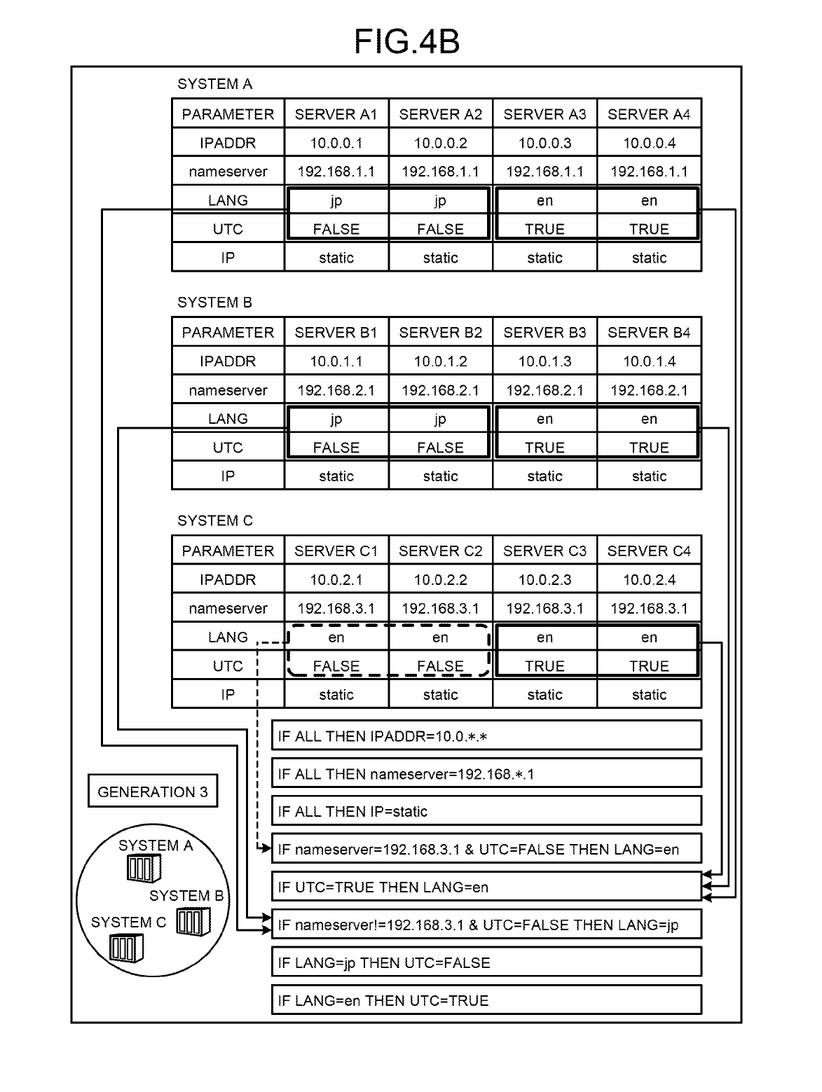

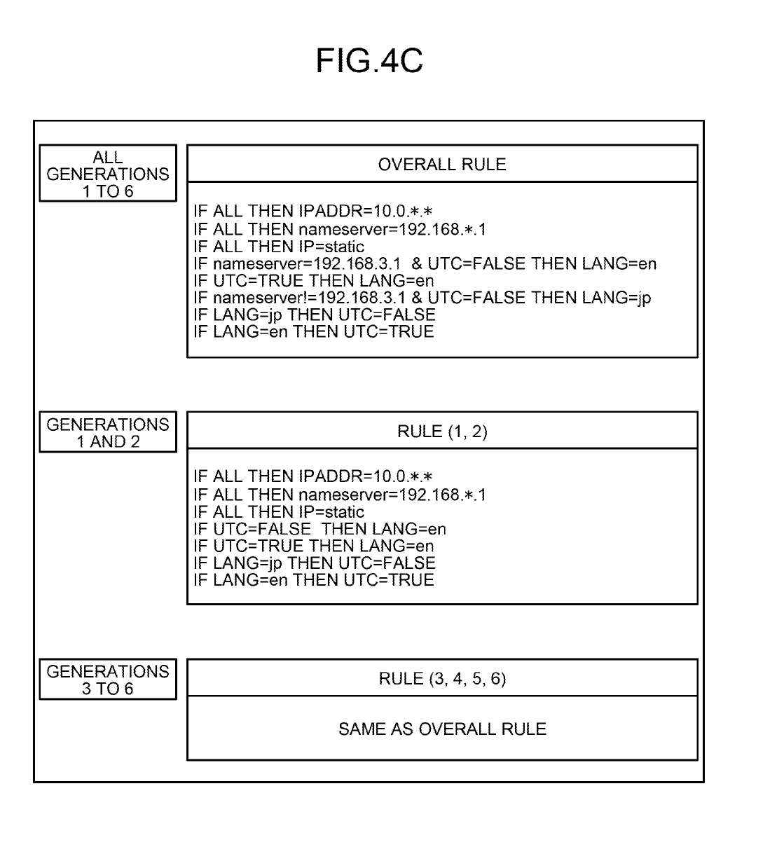

Here, an example of the rule extraction process will be described with reference to FIGS. 4A to 4C. FIGS. 4A to 4C are diagrams that illustrates examples of the rule extraction process.

FIG. 4A illustrates a rule extraction process of a plurality of systems A, B, and C belonging to Generation 1. The individual generation rule extracting unit 22 specifies a common portion in units of systems from the parameter setting histories 12 of the plurality of systems A, B, and C belonging to Generation 1 by using the clustering technique. Here, the individual generation rule extracting unit 22 specifies the value of the parameter “LANG” and the value of the parameter “UTC” that are set for each server as common portions. In other words, in Generation 1, in a case where the parameter “UTC” is “FALSE”, the parameter “LANG” is “jp”, and, in a case where the parameter “UTC” is “TRUE”, the parameter “LANG” is “en”. In addition, the individual generation rule extracting unit 22 specifies the value of the parameter “IP” set for each server as a common portion. In other words, in Generation 1, all the values of the parameter “IP” are “static”.

In addition, within a system or between systems, in a case where the value of a parameter changes in an incremental manner, in a setting rule of this parameter, “*” will be used as a portion to be changed. Here, the individual generation rule extracting unit 22 specifies the value of the parameter “IPADDR” set for each server as a common portion. In other words, in Generation 1, the parameter “IPADDR” is represented as “10.0.*.*”. In addition, the individual generation rule extracting unit 22 specifies the value of the parameter “nameserver” set for each server as a common portion. In other words, in Generation 1, the parameter “nameserver” is represented as “192.168.*.1”. Such common portions are specified as a result of the clustering.

Then, the individual generation rule extracting unit 22 extracts a setting rule of Generation 1 from the result of the clustering. Here, the individual generation rule extracting unit 22 extracts a setting rule of “IF ALL THEN IPADDR=10.0.*.*”. In addition, the individual generation rule extracting unit 22 extracts a setting rule of “IF ALL THEN nameserver=192.168.*.1”. The individual generation rule extracting unit 22 extracts a setting rule of “IF ALL THEN IP=static”. In addition, the individual generation rule extracting unit 22 extracts a setting rule of “IF UTC=FALSE THEN LANG=jp”. The individual generation rule extracting unit 22 extracts a setting rule of “IF UTC=TRUE THEN LANG=en”. In addition, the individual generation rule extracting unit 22 extracts a setting rule of “IF LANG=jp THEN UTC=FALSE”. The individual generation rule extracting unit 22 extracts a setting rule of “IF LANG=en THEN UTC=TRUE”.

FIG. 4B illustrates a rule extraction process of a plurality of systems A, B, and C belonging to Generation 3. In Generation 3, a parameter setting history 12 having an error is included. In other words, for servers C1 and C2 of the system C, in a case where the value of the parameter “UTC” is “FALSE”, “en” is set to the value of the parameter “LANG”. The rule extraction process of parameters other than the parameter “LANG” is similar to that of Generation 1 illustrated in FIG. 4A, and thus, description thereof will not be presented.

Here, the individual generation rule extracting unit 22 specifies the value of the parameter “LANG” and the value of the parameter “UTC” set in the systems A and B as common portions. The individual generation rule extracting unit 22 specifies the value of the parameter “LANG” and the value of the parameter “UTC” set in the systems C as a common portion. In other words, in Generation 3, in the systems A and B, in a case where the parameter “UTC” is “FALSE”, the parameter “LANG” is “jp”. In the system C, in a case where the parameter “UTC” is “FALSE”, the parameter “LANG” is “en”. For the parameter “LANG”, such common portions are specified as a result of the clustering.

Then, the individual generation rule extracting unit 22 extracts a setting rule of Generation 3 from the result of the clustering. Here, the individual generation rule extracting unit 22 extracts the following setting rules for the parameter “LANG”. The individual generation rule extracting unit 22 extracts a setting rule of “IF nameserver=192.168.3.1 & UTC=FALSE THEN LANG=en”. In addition, the individual generation rule extracting unit 22 extracts a setting rule of “IF UTC=TRUE THEN LANG=en”. Furthermore, the individual generation rule extracting unit 22 extracts a setting rule of “IF nameserver!=192.168.3.1 & UTC=FALSE THEN LANG=jp”.

Here, in a case where the parameter setting information of Generation 2 is the same as that of Generation 1, the individual generation rule extracting unit 22 extracts the same setting rule as the setting rule of Generation 1 that is illustrated in FIG. 4A as a setting rule of Generation 2. In a case where the parameter setting information of Generations 4 to 6 is the same as that of Generation 3, the individual generation rule extracting unit 22 extracts the same setting rules as the setting rule of Generation 3 illustrated in FIG. 4B as setting rules of Generations 4 to 6. For the parameter setting information of such Generations 1 to 6, the overall generation rule extracting unit 21 extracts the same setting rule as the setting rule of Generation 3 illustrated in FIG. 4B as a setting rule of all the generations of Generations 1 to 6.

FIG. 4C represents setting rules of each of Generations 1 to 6 that are extracted by the individual generation rule extracting unit 22. In addition, setting rules of all the Generations 1 to 6 extracted by the overall generation rule extracting unit 21 are represented. Hereinafter, the setting rules of all the generations will be referred to as “overall rules”.

Referring back FIG. 1, the different rule specifying unit 23 compares the overall rules extracted by the overall generation rule extracting unit 21 with the setting rules of each generation that are extracted by the individual generation rule extracting 22 and specifies different setting rules relating to settings of parameters that are common. For example, the different rule specifying unit 23 sequentially selects one generation from among a plurality of generations, compares the overall rules with the setting rules of the selected generation, and specifies different setting rules relating to settings of parameters that are common.

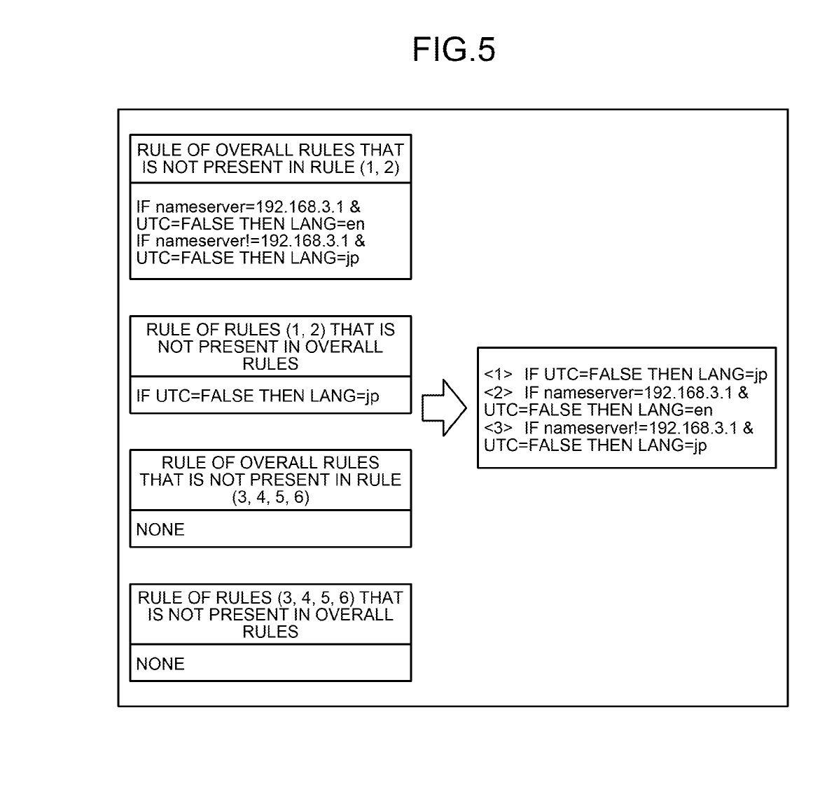

Here, the process of specifying different rules that is performed by the different rule specifying unit 23 will be described with reference to FIG. 5. FIG. 5 is a diagram that illustrates an example of specifying different rules. The description will be presented with reference to FIG. 5 using the overall rules and the setting rules of each generation illustrated in FIG. 4C. Numbers represented inside a parenthesis following each rule illustrated in FIG. 5 represent corresponding generations.

On the first and second stages illustrated in FIG. 5, a result of a comparison between the overall rules and the setting rules of Generation 1 (and Generation 2) is represented. The different rule specifying unit 23 selects Generation 1 from among Generations 1 to 6, compares the overall rules with the setting rules of Generation 1 that has been selected, and specifies different rules relating to settings of parameters that are common. Here, different setting rules relating to settings of the parameter “LANG” are specified. As a setting rule of the overall rules that is not present in the setting rules of Generation 1, “IF nameserver=192.168.3.1 & UTC=FALSE THEN LANG=en” is specified. As a setting rule similar thereto, “IF nameserver!=192.168.3.1 & UTC=FALSE THEN LANG=jp” is specified. In addition, as a setting rule of the setting rules of Generation 1 that is not present in the overall rules, “IF UTC=FALSE THEN LANG=jp” is specified. In addition, also in a case where Generation 2 is selected, the different rule specifying unit 23 specifies setting rules similar to those of the case where Generation 1 is selected as different setting rules.

On the third and fourth stages illustrated in FIG. 5, a result of a comparison between the overall rules and the setting rules of Generation 3 (and Generations 4 to 6) is represented. The different rule specifying unit 23 selects Generation 3 from among Generations 1 to 6, compares the overall rules with the setting rules of Generation 3 that has been selected, and specifies different rules relating to settings of parameters that are common. Here, since the overall rules and the setting rules of Generation 3 are the same, any different setting rule is not specified. In other words, as a setting rule of the overall rules that is not present in the setting rules of Generation 3, no setting rule is specified. In addition, as a setting rule of the setting rules of Generation 3 that is not present in the overall rules, no setting rule is specified. In addition, also in a case where any one of Generations 4 to 6 is selected, the different rule specifying unit 23, as in the case where Generation 3 is selected, any different setting rule is not specified.

Referring back to FIG. 1, the reliability calculating unit 24 calculates a degree of reliability of the different setting rule specified by the different rule specifying unit 23 based on a rule relating to a generation having the different setting rule. Here, the degree of reliability is an example of an index that represents a degree of certainty. For example, as a rule relating to generations, there is a rule that as a generation having a different setting rule is newer and is continuous, the degree of reliability is high. This rule includes that, even when setting rules correspond to a same setting rule, the setting rules that are not continuous for generations are handled as different setting rules. In such a rule, the reliability calculating unit 24 calculates the degree of reliability of the different setting rule based on the following Equation (1). In Equation (1), T_{new}(R) represents a latest generation of the different setting rule. In addition, Tₗₐₛₜ(R) represents the oldest generation of the different setting rule. T_{range}(R) represents a difference between the oldest generation and the latest generation of the another setting rule, in other words, a difference acquired by subtracting T_{new}(R) from Tₗₐₛₜ(R). Here, N represents the number of all the generations.

$$Degree of Reliability ( R ) = - {\sum }_{t = {T}_{new} ( R )}^{{T}_{last} ( R )} \frac{1}{t} \times \frac{{T}_{range} ( R )}{N} log \frac{{T}_{range} ( R )}{N} \qquad ( 1 )$$

In Equation (1), a part of “T_{range}(R)/N×log T_{range}(R)/N^{”} represents entropy (information amount), and, as the generation is continuous, the information amount increases. In addition, a part of “1/t” represents a weighting factor for a generation, and, as the generation is newer, the information amount increases. In other words, based on Equation (1), as the generation is continuous and is newer, the degree of reliability of a setting rule has a higher value. In other words, the degree of certainty of the setting rule has a larger value.

For example, the reliability calculating unit 24 calculates a degree of reliability based on Equation (1) for the different setting rules represented in FIG. 5. A degree of reliability of “IF UTC=FALSE THEN LANG=jp” of <1> specified as the different setting rule is calculated as in the following Equation (2) by applying Equation (1). A latest generation of this setting rule is “1”, and an oldest generation thereof is “2”. In addition, N is the number of all the generations and thus, is “6”.

$$Degree of Reliability ( R ) = - {\sum }_{t = 1}^{2} \frac{1}{t} \times \frac{2}{6} log \frac{2}{6} = 0.23856 \qquad ( 2 )$$

A degree of reliability of “IF nameserver=192.168.3.1 & UTC=FALSE THEN LANG=en” of <2> specified as the different setting rules is calculated as in the following Equation (3) by applying Equation (1). A latest generation of this setting rule is “3”, and an oldest generation thereof is “6”. In addition, N is the number of all the generations and thus, is “6”.

$$Degree of Reliability ( R ) = - {\sum }_{t = 3}^{6} \frac{1}{t} \times \frac{4}{6} log \frac{4}{6} = 0.11152 \qquad ( 3 )$$

A degree of reliability of “IF nameserver!=192.168.3.1 & UTC=FALSE THEN LANG=jp” of <3> specified as the different setting rule is calculated as in the following Equation (4) by applying Equation (1). A latest generation of this setting rule is “3”, and an oldest generation thereof is “6”. In addition, N is the number of all the generations and thus, is “6”.

$$Degree of Reliability ( R ) = - {\sum }_{t = 3}^{6} \frac{1}{t} \times \frac{4}{6} log \frac{4}{6} = 0.11152 \qquad ( 4 )$$

According to this, the degree of reliability of the setting rule of <1> is higher than the degrees of reliability of the setting rules of <2> and <3>. In other words, it can be understood that the degrees of reliability of the setting rules of Generations 1 and 2 are higher than those of the setting rules of Generations 3 to 6.

The reliability output unit 25 outputs the degrees of reliability of the different setting rules that are calculated by the reliability calculating unit 24. As an example, the reliability output unit 25 outputs the degrees of reliability of the different setting rules in a table form together with the setting rules and the generations. As another example, the reliability output unit 25 outputs the degrees of reliability of the different setting rules in a graph form together with the generations.

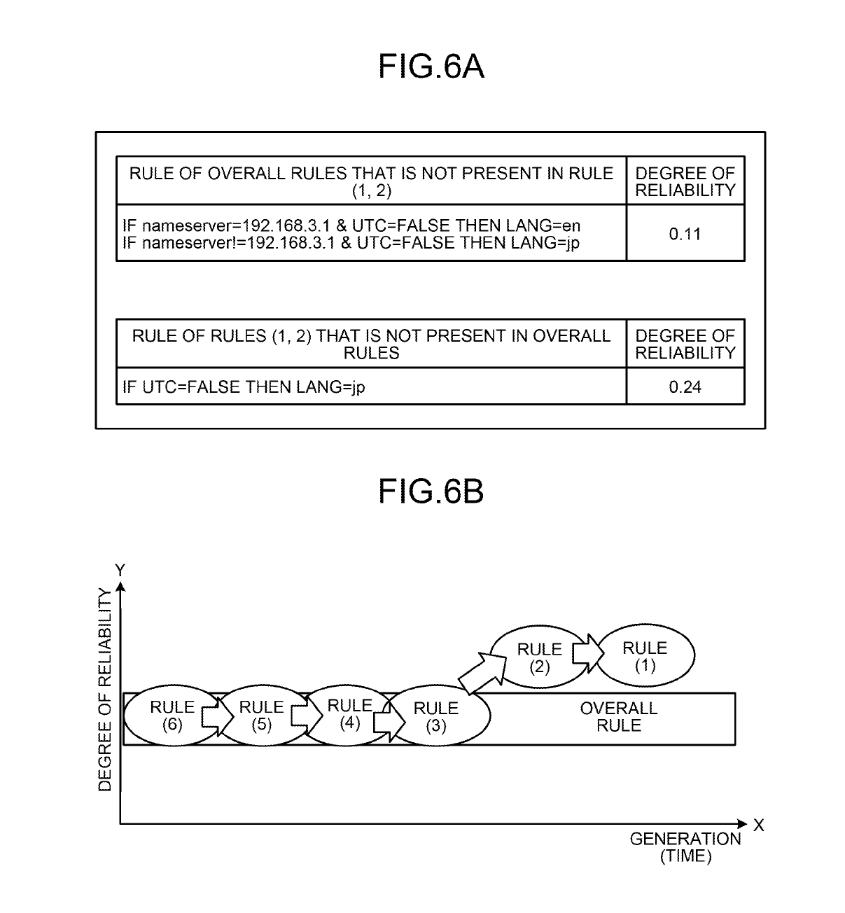

Here, an example of the output of the degrees of reliability that is performed by the reliability output unit 25 will be described with reference to FIGS. 6A and 6B. FIG. 6A is a diagram that illustrates an example of the output of the degrees of reliability in a table form. FIG. 6B is a diagram that illustrates an example of the output of degrees of reliability in a graph form.

As illustrated in FIG. 6A, the reliability output unit 25 outputs the degrees of reliability of the different setting rules together with the setting rules. At this time, the reliability output unit 25 outputs whether or not the different setting rule is present in a setting rule of a specific generation. For example, in a case where the different setting rules is “IF nameserver=192.168.3.1 & UTC=FALSE THEN LANG=en”, “0.11” is output as the degree of reliability. At this time, this setting rule indicating being present in the overall rules but not being present in the setting rules of Generations 1 and 2 is output together. In a case where the different setting rules is “IF UTC=FALSE THEN LANG=jp”, “0.24” is output as a degree of reliability. At this time, this setting rule indicating being present in the setting rules of Generations 1 and 2 but not being present in the overall rules is output together. Accordingly, the reliability output unit 25 can present the degrees of reliability of the different setting rules to the designer.

As illustrated in FIG. 6B, the reliability output unit 25 outputs the degrees of reliability of the different setting rules together with the generations. Here, the Y axis represents the degrees of reliability of the different setting rules, and the X axis represents the generation. In addition, each number represented inside parentheses following a setting rule represents a corresponding generation. Accordingly, the reliability output unit 25 can present the degrees of reliability of the overall rules and the degrees of reliability of the setting rules of each generation together to the designer.

Referring back to FIG. 1, the optimization unit 26 optimizes the teacher data 11 based on the degrees of reliability of the different setting rules output by the reliability output unit 25. For example, in a case where a setting rule is selected from among the different setting rules output by the reliability output unit 25, the optimization unit 26 determines whether or not the degree of reliability of the selected setting rule is higher than the degrees of reliability of the other setting rules. The setting rules to be compared with each other are setting rules relating to the settings of common parameters. In a case where the degree of reliability of the selected setting rule is higher than the degrees of reliability of the other setting rules, the optimization unit 26 reflects the selected setting rule on generations different from the generations having the selected setting rule. Then, the optimization unit 26 rewrites the parameter setting history 12 of each generation to which the selected setting rule has been applied. In other words, the optimization unit 26 optimizes the parameter setting history 12. On the other hand, in a case where the degree of reliability of the selected setting rule is lower than the degrees of reliability of the other setting rules, the optimization unit 26 holds the reflection of the selected setting rule. In this way, by leaving correct information as the setting histories of parameters, the optimization unit 26 can generate a setting rule having a high degree of accuracy and set parameters of a new generation with a high degree of accuracy.

For example, the setting rule “IF UTC=FALSE THEN LANG=jp” illustrated in FIG. 6A is assumed to be selected. Then, since the degree of reliability of the selected setting rule of 0.24 is higher than that of the other setting rule 0.11, the optimization unit 26 reflects the selected setting rule on Generations 3 to 6 different from Generations 1 and 2 having the selected setting rule. Here, the selected setting rule “IF UTC=FALSE THEN LANG=jp” is applied to Generations 3 to 6. Then, the parameter setting histories 12 of Generations 3 to 6 are rewritten. Here, for the parameter “LANG” of the system C illustrated in FIG. 3B, the values of the servers C1 and C2 of which the parameter “UTC” is “FALSE” are rewritten from “en” to “jp”.

### Sequence of Setting Support Process

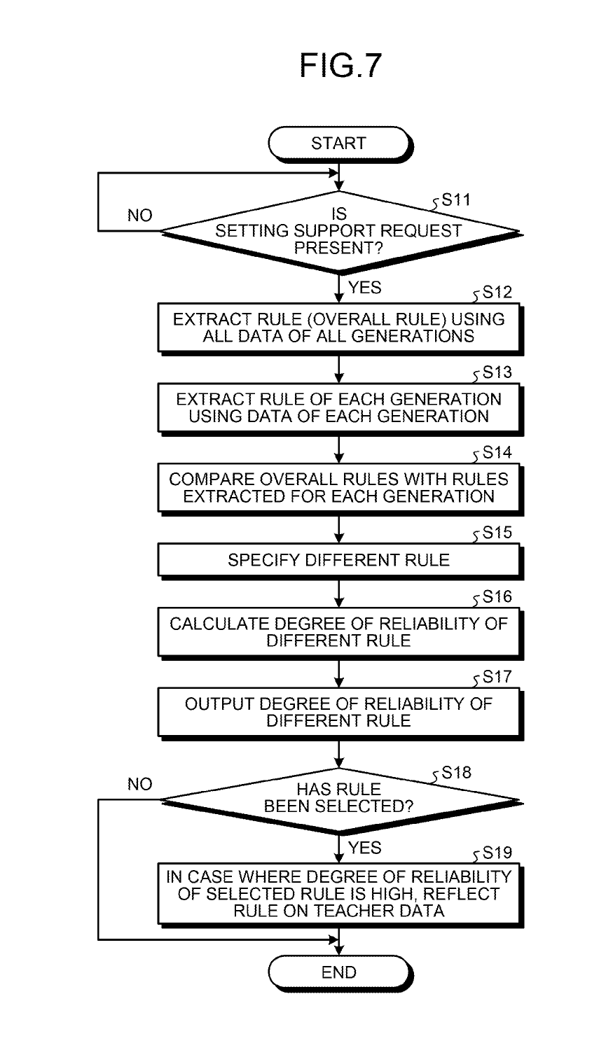

Next, the sequence of the setting support process will be described with reference to FIG. 7. FIG. 7 is a diagram that illustrates a flowchart of the setting support process according to the embodiment. The setting information of parameters of a plurality of systems of an existing data center is stored in the parameter setting history 12 for each generation.

First, the overall generation rule extracting unit 21 determines whether or not a setting support request is present in Step S11. In a case where the setting support request is determined not to be present (No in Step S11), the overall generation rule extracting unit 21 repeats the determination process until a setting support request is present. On the other hand, in a case where a setting support request is determined to be present (Yes in Step S11), the overall generation rule extracting unit 21 extracts setting rules (overall rules) of parameters common to the plurality of systems by using all the data (parameter setting histories 12) of all the generations in Step S12. Here, the setting rules are extracted using the clustering technique.

Then, the individual generation rule extracting unit 22 extracts setting rules for each generation of parameters common to the plurality of systems by using the data (the parameter setting history 12) of each generation in Step S13. In addition, the setting rules are extracted using the same technique as the clustering technique used by the overall generation rule extracting unit 21.

Subsequently, the different rule specifying unit 23 compares the overall rules with setting rules extracted for each generation in Step S14. Then, the different rule specifying unit 23 specifies different setting rules relating to the setting of common parameters in Step S15.

Subsequently, the reliability calculating unit 24 calculates the degrees of reliability of the different setting rules based on a rule relating to a generation having the different setting rules in Step S16. For example, the reliability calculating unit 24 calculates the degrees of reliability of the different setting rules based on Equation (1).

Then, the reliability output unit 25 outputs the degrees of reliability of the different setting rules in Step S17. For example, the reliability output unit 25 outputs the degrees of reliability of the different setting rules in a table form to a monitor of the setting support device 1 together with the setting rule and the generation.

Subsequently, the optimization unit 26 determines whether or not any one setting rule is selected from among the different setting rules output by the reliability output unit 25 in Step S18. In a case where any one setting rule is determined not to have been selected (No in Step S18), the setting support process ends.

On the other hand, in a case where any one setting rule is determined to have been selected (Yes in Step S18), when the degree of reliability of the selected setting rule is higher than the degrees of reliability of the other setting rules, the optimization unit 26 reflects the selected setting rule on the teacher data 11 in Step S19. For example, in a case where the degree of reliability of the selected setting rule is higher than the degrees of reliability of the other setting rules, the optimization unit 26 applies the selected setting rule to generations different from the generations having the selected setting rule. Then, the optimization unit 26 rewrites the parameter setting history 12 of the generation to which the selected setting rule has been applied. Then, the setting support process ends.

### Advantages of Embodiment

According to the above-described embodiment, the setting support device 1 generates settings of parameters common to a plurality of systems and conditions used for the settings as a first rule based on the parameter setting information relating to the settings of parameters performed for the plurality of systems in the past. Then, the setting support device 1 generates settings of parameters common to the plurality of systems and conditions used for the settings as a second rule for each generation based on the parameter setting information of each generation relating to the settings of parameters performed in the past for the plurality of systems. Then, the setting support device 1 compares the first rule with the second rule of each generation in relation with the setting of common parameters, specifies different rules, and calculates indexes representing the degrees of certainty of the specified different rules. According to such a configuration, in a case where there is a difference in the setting rules of common parameters, the setting support device 1 can present the degree of certainty of the different setting rules to the designer and allow the designer to acquire the degree of certainty of the different setting rules.

In addition, according to the embodiment described above, the setting support device 1, based on a rule relating to generations having a different rule therebetween, calculates indexes representing the degree of certainty of the different rules. According to such a configuration, the setting support device 1 calculates an index representing the degree of certainty of a different rule in consideration of the generation, thereby calculating an index having high accuracy.

In addition, according to the embodiment described above, the setting support device 1 calculates an index representing the degree of certainty to be higher as a generation having the different rule is newer and is continuous. According to such a configuration, the setting support device 1 calculates the index representing the degree of certainty of the different rule in consideration of the generation, thereby calculating an index having high accuracy.

### Others

In addition, the setting support device 1 can be realized by implementing the functions of the different rule specifying unit 23, the reliability calculating unit 24, and the like in an information processing apparatus such as an existing personal computer or a workstation.

In the embodiment described above, the reliability calculating unit 24 calculates the degree of reliability of a different setting rule specified by the different rule specifying unit 23 based on the rule relating to the generation having the different setting rule. At this time, an example of the rule relating to the generation has been described as a rule that as a generation having a different setting rule is newer and is continuous, the reliability increases. However, the rule relating to the generation is not limited thereto, but in a case where a different setting rule is included only in a latest generation, the degree of reliability may be configured to decrease. The reason for this is that, in the case where the setting rule is included only in the latest generation, the result is still insufficient. For example, the reliability calculating unit 24 may be configured to decrease the degree of reliability calculated using Equation (1) by a predetermined adjustment value.

In addition, each constituent element of the device illustrated in each figure does not necessarily need to be physically configured as illustrated in the figure. In other words, a specific embodiment of division/integration of the device is not limited to that illustrated in the figure, but the whole or a part thereof may be configured to be integrated/divided functionally or physically in an arbitrary unit based on various loads, use statuses, and the like. For example, the overall generation rule extracting unit 21 and the individual generation rule extracting unit 22 may be integrated as one unit. On the other hand, the overall generation rule extracting unit 21 may be divided into a storing unit that receives the teacher data 11 from an existing data center and stores the teacher data 11 in the storage unit 10 and an extraction unit that extracts the overall generation rule. In addition, the storage unit 10 may be stored in an external device of the setting support device 1, or an external device storing the storage unit 10 may be configured to be connected to the setting support device 1 through a network.

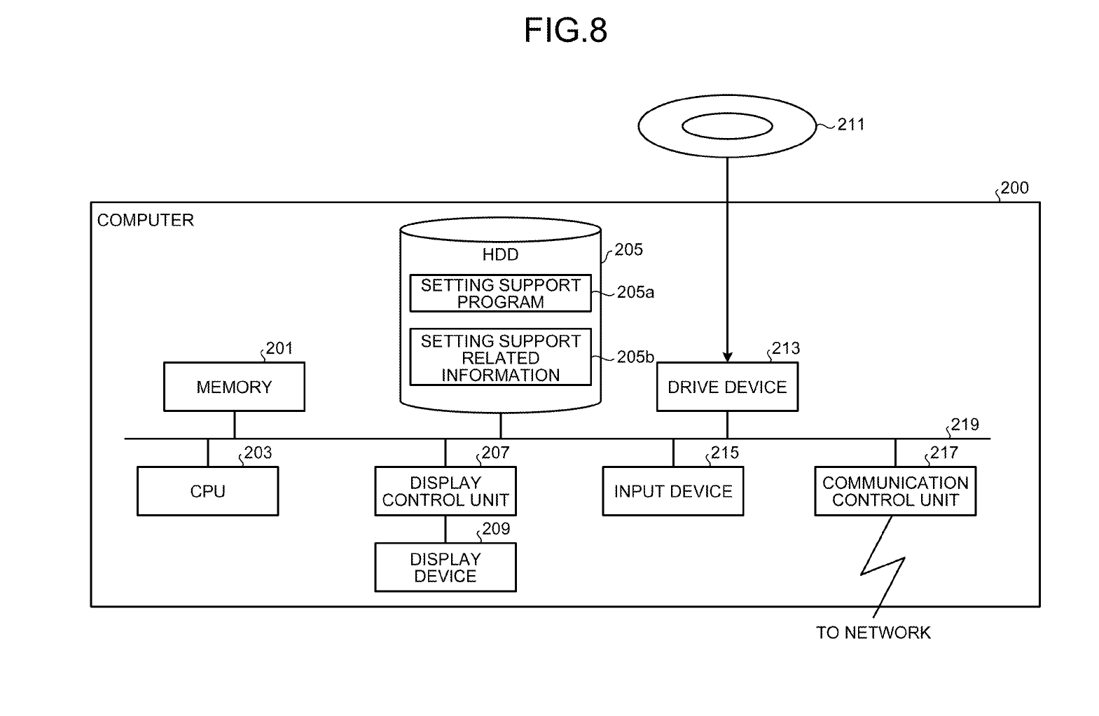

In addition, various processes described in the embodiment described above may be realized by executing a program prepared in advance by using a computer such as a personal computer or a workstation. Thus, hereinafter, an example of a computer that executes a setting support program realizing the same function as that of the setting support device 1 illustrated in FIG. 1 will be described. FIG. 8 is a diagram that illustrates an example of a computer executing the setting support program.

As illustrated in FIG. 8, a computer 200 includes: a CPU 203 that executes various calculation processes; an input device 215 that receives an input of data from a user; and a display control unit 207 that controls a display device 209. In addition, the computer 200 includes a drive device 213 that reads a program and the like from a storage medium and a communication control unit 217 that transmits/receives data to/from another computer through the network. Furthermore, the computer 200 includes a memory 201 that temporarily stores various kinds of information and an HDD 205. The memory 201, the CPU 203, the HDD 205, the display control unit 207, the drive device 213, the input device 215, and the communication control unit 217 are interconnected through a bus 219.

The drive device 213, for example, is a device for a removable disk 211. The HDD 205 stores a setting support program 205a and setting support related information 205b.

The CPU 203 reads the setting support program 205a, expands the setting support program in the memory 201, and executes the setting support program as processes. The processes correspond to the functional units of the setting support device 1 respectively. The setting support related information 205b corresponds to the teacher data 11. For example, the removable disk 211 stores various kinds of information such as the teacher data 11.

In addition, the setting support program 205a may be configured not to be necessarily stored in the HDD 205 from the start. For example, the program is stored in a “portable physical medium” such as a flexible disk (FD), a CD-ROM, a DVD disc, a magneto-optical disk, or an IC card inserted into the computer 200. Then, the computer 200 may be configured to read the setting support program 205a therefrom and executes the setting support program 205a.

The degree of certainty of a setting rule of parameters can be acquired.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium having stored therein a setting support program for causing a computer to execute a process comprising:
generating a setting of parameters common to a plurality of devices and a condition used for the setting as a first rule based on information relating to settings of the parameters performed for the plurality of devices in the past;
generating a setting of parameters common to the plurality of devices and a condition used for the setting as a second rule for each generation based on information of each generation that relates to settings of the parameters performed for the plurality of devices in the past;
comparing the first rule and the second rule with each other in relation to the setting of the parameters that is common;
specifying a different rule; and
calculating an index representing a degree of certainty of the specified different rule.

2. The non-transitory computer-readable recording medium according to claim 1, wherein the calculating includes calculating the index representing the degree of certainty of the specified different rule based on a rule relating to a generation having the different rule.

3. The non-transitory computer-readable recording medium according to claim 2, wherein the calculating includes calculating the index to have a higher degree of certainty as the generation having the different rule is newer and is continuous.

4. The non-transitory computer-readable recording medium according to claim 3, wherein the calculating includes calculating the index to have a higher degree of certainty as the generation having the different rule is newer and is continuous by using an identification number for the generation having the different rule, the number of generations in which the generation having the different rule is continuous, and the total number of generations.

5. A setting support device comprising:
a processor;
a memory, wherein the processor executes:
generating a setting of parameters common to a plurality of devices and a condition used for the setting as a first rule based on information relating to settings of the parameters performed for the plurality of devices in the past;
generating a setting of parameters common to the plurality of devices and a condition used for the setting as a second rule for each generation based on information of each generation that relates to settings of the parameters performed for the plurality of devices in the past;
comparing the first rule and the second rule with each other in relation to the setting of the parameters that is common, specifying a different rule, and calculating an index representing a degree of certainty of the specified different rule.

6. A setting support method comprising:
generating a setting of parameters common to a plurality of devices and a condition used for the setting as a first rule based on information relating to settings of the parameters performed for the plurality of devices in the past by a processor;
generating a setting of parameters common to the plurality of devices and a condition used for the setting as a second rule for each generation based on information of each generation that relates to settings of the parameters performed for the plurality of devices in the past by the processor; and
comparing the first rule and the second rule with each other in relation to the setting of the parameters that is common, specifying a different rule, and calculating an index representing a degree of certainty of the specified different rule by the processor.
